(19) United States
(12) Patent Application Publication
(10) Pub. No.: US 2012/0258642 A1
(43) Pub. Date: Oct. 11, 2012

(54) Carbon fiber woven fabric

(76) Inventor: Yao-Tang Chuang, Taipei (TW)

(21) Appl. No.: 13/084,523

(22) Filed: Apr. 11, 2011

(51) Int. Cl. B32B 5/26

(52) U.S. Cl. 442/239

(57) ABSTRACT

A carbon fiber woven fabric includes a plurality of yarns each comprising a plurality of carbon fibers bundled together; a plurality of surrounding textiles each securely surrounding the yarn to form a carbon filament; a base textile for supporting a plurality of the carbon filaments thereon; and a top textile fastened on both the base textile and the carbon filaments.

### BACKGROUND OF THE INVENTION

1. Field of the Invention

The invention relates to carbon fibers and more particularly to a carbon fiber woven fabric having each yarn being securely surrounded by a surrounding textile, the yarn having about 10,000 carbon fibers.

2. Description of Related Art

Carbon fiber is a material consisting of extremely thin fibers about 0.005-0.010 mm in diameter and composed mostly of carbon atoms. The carbon atoms are bonded together in microscopic crystals that are more or less aligned parallel to the long axis of the fiber. The crystal alignment makes the fiber very strong for its size. A plurality of (e.g., about 10,000) carbon fibers are twisted together to form a yarn which may be used woven into a fabric. Carbon fiber based products have advantages including low weight, high tensile strength, and low thermal expansion. However, carbon fiber is weak when compressed or exposed to high shock. Thus, the need for improvement still exists.

### SUMMARY OF THE INVENTION

It is therefore one object of the invention to provide a carbon fiber woven fabric comprising a plurality of yarns each comprising a plurality of carbon fibers bundled together; a plurality of surrounding textiles each securely surrounding the yarn to form a carbon filament; a base textile for supporting a plurality of the carbon filaments; and a top textile fastened on both the base textile and the carbon filaments.

The above and other objects, features and advantages of the invention will become apparent from the following detailed description taken with the accompanying drawings.

### BRIEF DESCRIPTION OF THE DRAWINGS

FIG. 1 is an exploded view of a portion of a carbon fiber woven fabric according to the invention with a yarn being shown in a detailed view;

FIG. 2 is a perspective view showing the yarn and a surrounding textile being fastened together by stitching to form a carbon filament which is next fastened on a base textile; and

FIGS. 3 to 9 are plan views of the fastened carbon filaments and base textile to be woven into a fabric for covering ankle, elbow, wrist, waist, knee, shoulder, and both neck and back respectively.

### DETAILED DESCRIPTION OF THE INVENTION

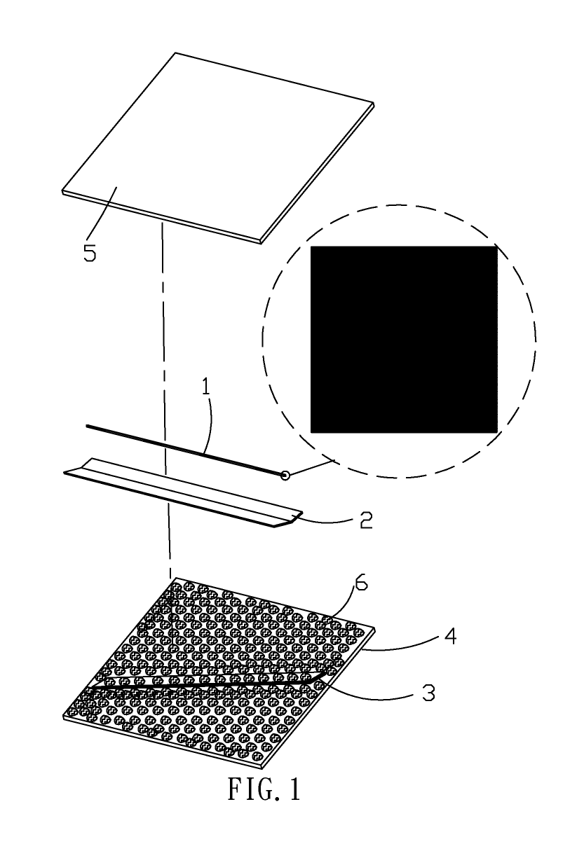

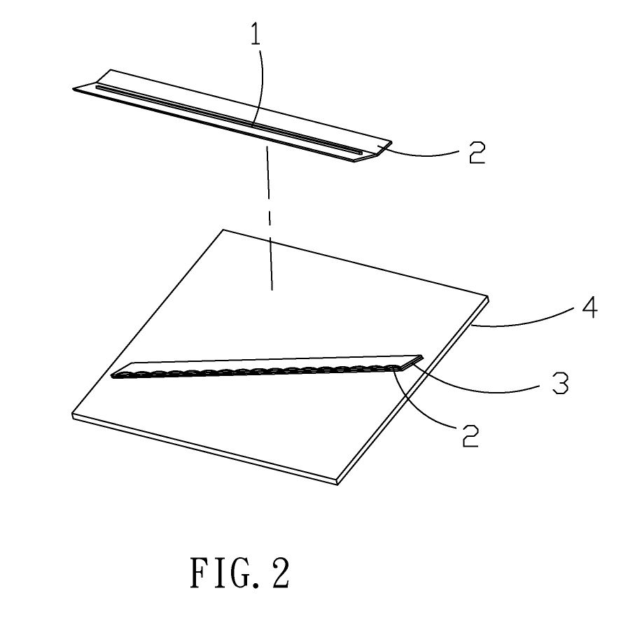

Referring to FIGS. 1 and 2, a carbon fiber woven fabric in accordance with the invention comprises the following components as discussed in detail below.

A yarn 1 comprises about 10,000 carbon fibers bundled together. Both ends of the yarn 1 can be electrically connected to positive and negative terminals of a power cord respectively so as to heat a fabric to be woven. The yarn 1 is next surrounded by a surrounding textile 2 to form a carbon filament 3 by either applying adhesive therebetween (see FIG. 1) or stitching (see FIG. 2). Adhesive 6 is applied on an inner surface of a base textile 4. Next, a plurality of carbon filaments 3 are placed on the base textile 4 so that the carbon filaments 3 can be fastened thereon. Next, a top textile 5 is placed on both the base textile 4 and the carbon filaments 3 and pressed so that the adhesive 6 may fasten the base textile 4, the carbon filaments 3, and the top textile 5 together to form a carbon fiber woven fabric.

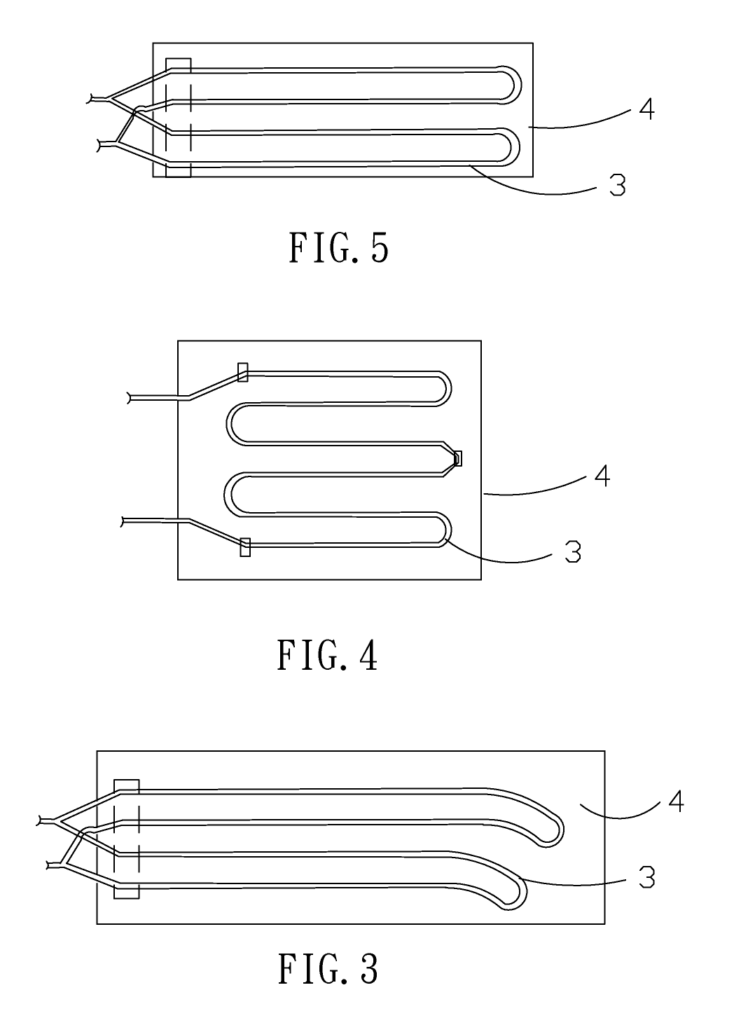

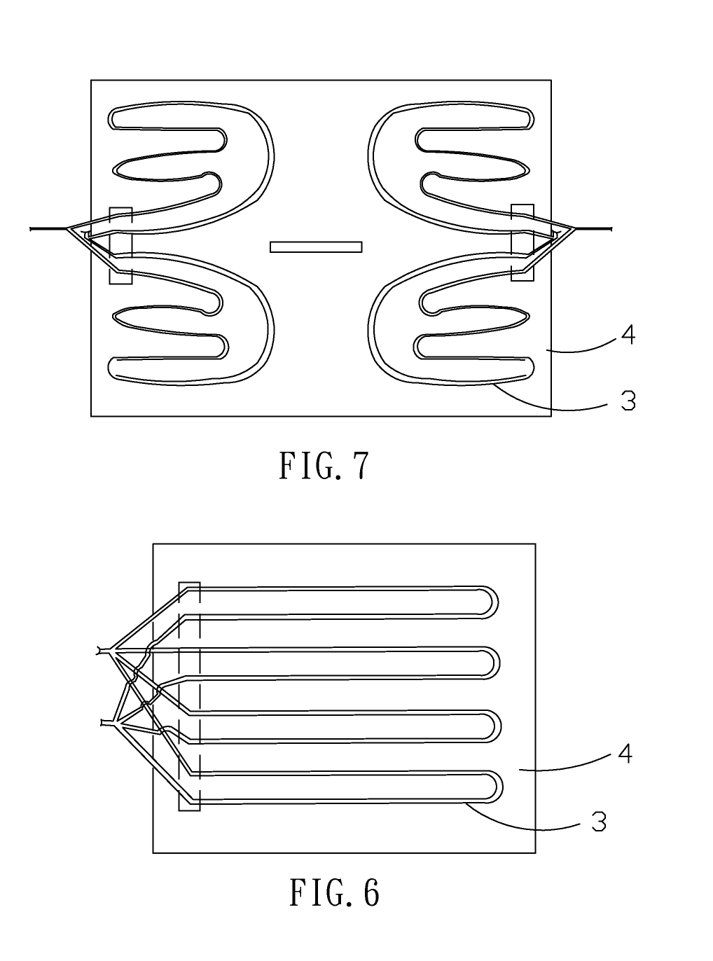

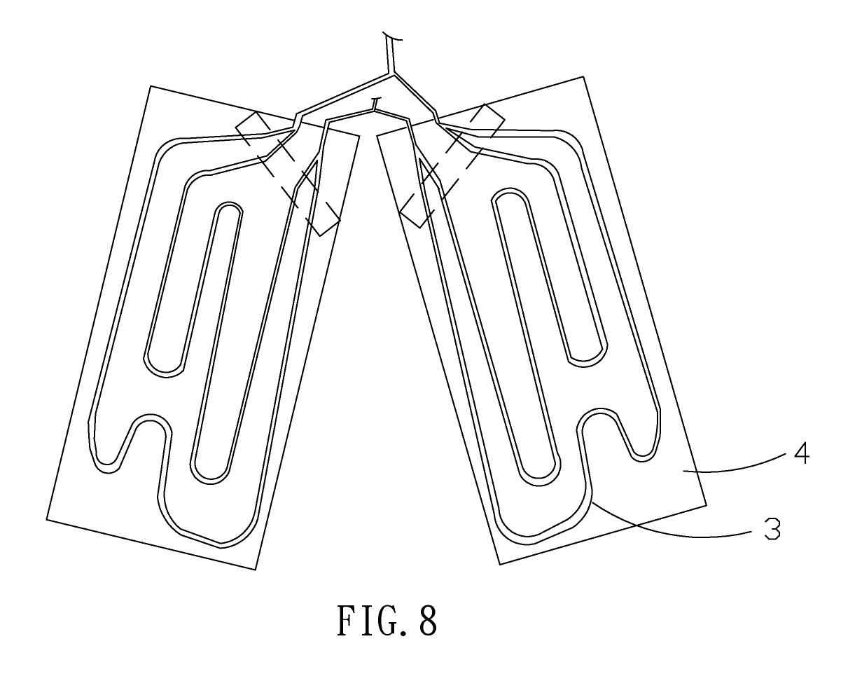

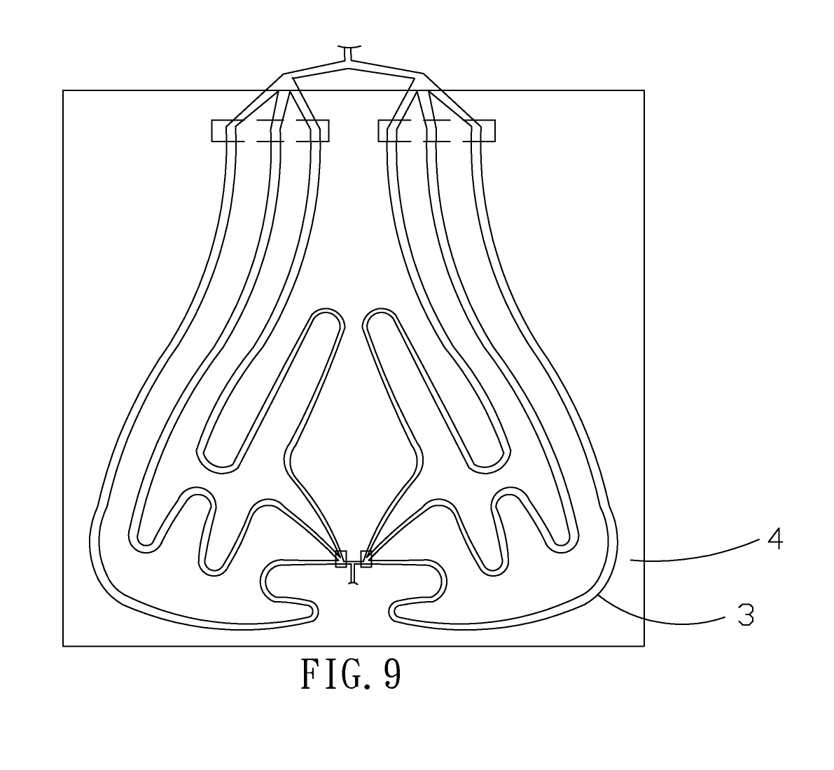

Referring to FIGS. 3 to 9, they are plan views of the fastened carbon filaments 3 and base textile 4 to be woven into a fabric for covering ankle, elbow, wrist, waist, knee, shoulder, and both neck and back respectively.

It is envisaged by the invention that the carbon filament 3 has an increased capability 10-20% of resisting breakage.

While the invention has been described in terms of preferred embodiments, those skilled in the art will recognize that the invention can be practiced with modifications within the spirit and scope of the appended claims.

What is claimed is:

1. A carbon fiber woven fabric comprising:
a plurality of yarns each comprising a plurality of carbon fibers bundled together;
a plurality of surrounding textiles each securely surrounding the yarn to form a carbon filament;
a base textile for supporting a plurality of the carbon filaments thereon; and
a top textile fastened on both the base textile and the carbon filaments.

2. The carbon fiber woven fabric of claim 1, wherein the surrounding textile and the yarn are fastened together by stitching.

3. The carbon fiber woven fabric of claim 1, wherein the surrounding textile and the yarn are fastened together by applying adhesive therebetween.
